(19) United States
(12) Patent Application Publication
(10) Pub. No.: US 2026/0350443 A1
(43) Pub. Date: Nov. 5, 2026

(54) QUANTUM MEASUREMENT DISCRIMINATION USING DISTRIBUTION FUNCTIONS

(71) Applicant: University of Florida Research Foundation, Incorporated, Gainesville, FL (US)

(72) Inventors: Prabhat Kumar MISHRA, Gainesville, FL (US); Daniel VOLYA, Gainesville, FL (US); Zachery Steven UTT, Gainesville, FL (US)

(21) Appl. No.: 18/439,968

(22) Filed: Feb. 13, 2024

Related U.S. Application Data
(60) Provisional application No. 63/487,366, filed on Feb. 28, 2023.

(51) Int. Cl. G06N 10/20

(52) U.S. Cl. CPC G06N 10/20

(57) ABSTRACT

A classical computing entity operates a distribution function discriminator to obtain a set of qudit measurements. The set of qudit measurements comprises a plurality of qudit measurements that each correspond to a respective quantum state of one or more qudits as a result of performance of a quantum circuit by a quantum computer comprising the qudits. The discriminator determines a respective distribution function for each qudit based on the set of qudit measurements, obtains respective distribution functions for each qudit state of the qudits, and, for each qudit and based on the respective distribution functions for the qudit and each of the qudit states, determines a respective probability that the respective qudit was in a first qudit state as a result of the performance of the quantum circuit. The discriminator determines a measurement result for each of the qudits and provides an indication of the measurement results.

### CROSS-REFERENCE TO RELATED APPLICATIONS

This application claims priority to U.S. Application No. 63/487,366, filed Feb. 28, 2023, the content of which is incorporated herein by reference in its entirety.

### GOVERNMENT SUPPORT STATEMENT

This disclosure was made with government support under 1908131 awarded by The National Science Foundation. The government has certain rights in the disclosure.

### TECHNICAL FIELD

The present disclosure relates to interpreting quantum measurements. An example embodiment relates to the use of distribution functions to interpret measurements captured by a quantum computer.

### BACKGROUND

Quantum computing can efficiently solve many hard problems significantly faster than its classical counter-part. Quantum measurement is one of the critical steps in quantum computing that determines the probabilities associated with qubit states after conducting several quantum circuit and/or program executions and qubit measurements. The results of the qubit measurements provide the result of the performance of the quantum circuit and/or program.

As a mesoscopic quantum system, real quantum computers are prone to noise. Therefore, the measurements used to determine the result of the performance of the quantum circuit and/or program contain and/or affected by noise. This can make interpreting the qubit measurements to determine the result of the performance of the quantum circuit and/or program challenging.

### BRIEF SUMMARY OF EXAMPLE EMBODIMENTS

Various embodiments provide methods, systems, apparatus, computer program products, and/or the like for interpreting and/or discriminating qudit measurements using distribution functions. For example, various embodiments, use cumulative distribution functions to determine, interpret, and/or discriminate the state of one or more qudits as a result of performing a quantum circuit and/or function. A qudit is a quantum system comprising d quantum states, where d is a natural number of at least two. For example, a qubit is a qudit with d=2.

In an example embodiment, a classical computing entity executes executable instructions of program code configured for providing a distribution function discriminator. Execution of the executable instructions by the classical computing entity causes the distribution function discriminator to obtain a set of qudit measurements. The set of qudit measurements comprises a plurality of qudit measurements that each correspond to a respective quantum state of one or more qudits as a result of performance of a quantum circuit by a quantum computer comprising the one or more qudits. Execution of the executable instructions by the classical computing entity further causes the distribution function discriminator to determine a respective distribution function for each qudit of the one or more qudits based at least in part on the set of qudit measurements, obtain respective distribution functions for each qudit state of the d quantum states of the one or more qudits of the quantum computer, and, for each qudit of the one or more qudits, determine a respective bit probability that is a probability that the respective qudit was in a first qudit state as a result of the performance of the quantum circuit and/or program by the quantum computer. The respective bit probability is determined based on the respective distribution function for the qudit and the respective distribution functions for each qudit state of the d quantum states of the one or more qudits. Execution of the executable instructions by the classical computing entity further causes the distribution function discriminator to determine a measurement result based on the respective bit probability for each of the one or more qudits and provide an indication of the measurement result.

According to a first aspect, a method for providing an indication of a measurement result of a set of quantum measurements is provided. The method is performed by a distribution function discriminator operating on a classical computing entity. In an example embodiment, the method comprises obtaining a set of qudit measurements. The set of qudit measurements comprises a plurality of qudit measurements that each correspond to a respective quantum state of one or more qudits as a result of performance of a quantum circuit by a quantum computer comprising the one or more qudits. The method further comprises determining a respective distribution function for each qudit of the one or more qudits based at least in part on the set of qudit measurements; obtaining respective distribution functions for each qudit state of the one or more qudits of the quantum computer; and, for each qudit of the one or more qubits, determining a respective bit probability for a first qudit state based on the respective distribution function for the qudit and the respective distribution functions for each qudit state. The method further comprises determining a measurement result based on the respective bit probability for each of the one or more qudits; and providing an indication of the measurement result.

According to another aspect, a classical computing entity configured to operate a distribution function discriminator is provided. In an example embodiment, the classical computing entity comprises at least one processing element and at least one non-transitory memory storing executable instructions configured for providing the distribution function discriminator. The executable instructions, when executed by the at least one processing element, are configured to cause the classical computing entity to perform obtaining a set of qudit measurements. The set of qudit measurements comprises a plurality of qudit measurements that each correspond to a respective quantum state of one or more qudits as a result of performance of a quantum circuit by a quantum computer comprising the one or more qudits. The executable instructions, when executed by the at least one processing element, are configured to cause the classical computing entity to further perform determining a respective distribution function for each qudit of the one or more qudits based at least in part on the set of qudit measurements; obtaining respective distribution functions for each qudit state of the one or more qudits of the quantum computer; and, for each qudit of the one or more qudits, determining a respective bit probability for a first qudit state based on the respective distribution function for the qudit and the respective distribution functions for each qudit state. The executable instructions, when executed by the at least one processing element, are configured to cause the classical computing entity to further perform determining a measurement result based on the respective bit probability for each of the one or more qudits; and providing an indication of the measurement result.

According to another aspect, a computer program product comprising at least one non-transitory storage medium is provided. In an example embodiment, the at least one storage medium stores computer executable instructions configured for providing a distribution function discriminator. The executable instructions are configured to, when executed by a processing element of a classical computing entity, cause the classical computing entity to perform obtaining a set of qudit measurements. The set of qudit measurements comprises a plurality of qudit measurements that each correspond to a respective quantum state of one or more qudits as a result of performance of a quantum circuit by a quantum computer comprising the one or more qudits. The executable instructions are further configured to, when executed by a processing element of a classical computing entity, cause the classical computing entity to perform determining a respective distribution function for each qudit of the one or more qudits based at least in part on the set of qudit measurements; obtaining respective distribution functions for each qudit state of the one or more qudits of the quantum computer; and, for each qudit of the one or more qudits, determining a respective bit probability for a first qudit state based on the respective distribution function for the qudit and the respective distribution functions for each qudit state. The executable instructions are configured to, when executed by a processing element of a classical computing entity, cause the classical computing entity to further perform determining a measurement result based on the respective bit probability for each of the one or more qudits; and providing an indication of the measurement result.

According to another aspect, a method for providing an indication of a measurement result of a set of quantum measurements is provided. The method is performed by a distribution function discriminator operating on a classical computing entity. In an example embodiment, the method comprises obtaining a set of qubit measurements. The set of qubit measurements comprises a plurality of qubit measurements that each correspond to a respective quantum state of one or more qubits as a result of performance of a quantum circuit by a quantum computer comprising the one or more qubits. The method further comprises determining a respective distribution function for each qubit of the one or more qubits based at least in part on the set of qubit measurements; obtaining respective distribution functions for a first qubit state and a second qubit state of the one or more qubits of the quantum computer; and, for each qubit of the one or more qubits, determining a respective bit probability for a first qubit state based on the respective distribution function for the qubit and the respective distribution functions for the first qubit state and the second qubit state. The method further comprises determining a measurement result based on the respective bit probability for each of the one or more qubits; and providing an indication of the measurement result.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a schematic diagram illustrating an example system, according to an example embodiment.

FIG. 2 is a flowchart illustrating processes, procedures, and/or operations performed by a classical computing entity to determine a distribution function for a plurality of qubit measurements, according to an example embodiment.

FIG. 3 is a flowchart illustrating processes, procedures, and/or operations performed by a distribution function discriminator operating on a classical computing entity to provide an indication of a measurement result for a single qubit, according to an example embodiment.

FIG. 4 is a flowchart illustrating processes, procedures, and/or operations performed by a distribution function discriminator operating on a classical computing entity to provide an indication of a measurement result for a plurality of qubits, according to an example embodiment.

FIGS. 5A and 5B each provide a plot illustrating performance of an example distribution function discriminator compared to a conventional linear discriminator, according to respective embodiments.

FIG. 5C provides a plot illustrating performance of an example distribution function discriminator compared to a conventional linear discriminant analysis (LDA) discriminator and compared to a k nearest neighbor (kNN) discriminator, according to an example embodiment.

FIG. 5D provides a plot illustrating the improvement in multi-qutrit bit string reconstruction provided by correcting results of a kNN discriminator using techniques disclosed herein, in accordance with an example embodiment.

FIG. 6 provides a schematic diagram of an example classical computing entity that may be used in accordance with an example embodiment.

### DETAILED DESCRIPTION OF SOME EXAMPLE EMBODIMENTS

The present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “of” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Various embodiments provide methods, systems, apparatus, computer program products, and/or the like for interpreting and/or discriminating qubit measurements using distribution functions. For example, various embodiments, use cumulative distribution functions to determine, interpret, and/or discriminate the state of one or more qubits as a result of performing a quantum circuit and/or function.

For example, the quantum circuit and/or function is performed a plurality of times (e.g., a plurality of shots of the quantum circuit and/or function is performed). Each performance of the quantum circuit and/or function (e.g., shot) results in a qubit measurement for one or more qubits. Rather than classify the qubit measurement of each performance of the quantum circuit and/or function, various embodiments consider and/or process the properties of the qubit measurement distribution generated through the plurality of performances of the quantum circuit and/or function to determine a result of performing the quantum circuit and/or function.

Quantum computing is expected to significantly out-perform classical computing on many hard problems due to quantum mechanical effects such as entanglement and superposition. While a memory component of a classical computer (e.g., a bit) can only be in one possible state at a time, a memory component of a quantum computer (e.g., a qubit) can be in an arbitrary combination or superposition of states at the same time. Unfortunately, quantum computing also introduces a significant level of noise and uncertainty compared to classical computing. Moreover, the result of measuring a quantum state of a qubit of a quantum computer forces the arbitrary state of the qubit to one known state with some probability. Thus, to understand the result of performing a quantum circuit or program, the quantum circuit or program may be executed multiple times and the qubit measurement may be performed each time.

There are various sources of noise (errors) in quantum computers including (a) initial state preparation, (b) actual computation, and (c) measurement of results. Moreover, the noise or error introduced into the qubit measurements may be dependent on the quantum state of the qubit. As a result, the noise or error cannot be simply filtered out of the qubit measurements. Therefore, technical problems exist regarding how interpret the measurement results of a quantum computer.

Various embodiments provide technical solutions to these technical problems. In particular, various embodiments employ distribution function descriptions of a plurality of qubit measurements to determine the underlying probability that a qubit or a set of qubits (a logical qubit, for example) was/were in a particular quantum state as a result of the performance of a quantum circuit or program by a quantum computer comprising the qubit or set of qubits.

For example, conventional discriminators (e.g., linear discriminators) consider each qubit measurement independently. Thus, each shot or instance of performing the quantum circuit or program is considered independently. For example, a conventional discriminator may use a machine learning-trained classifier to classify an individual qubit measurement (e.g., a single measurement of a single qubit) as either being in the first qubit state or the second qubit state (e.g., |0 [symbol] or |1 [symbol] ). However, due to the noise present in the qubit measurements, conventional discriminators are not able to map the individual qubit measurements to respective qubit states with high confidence.

As various embodiments consider the distribution function of a set of qubit measurements that includes a plurality of qubit measurements, the distribution/statistical information encoded in the distribution function enables the distribution function discriminator to provide high confidence mapping of a set of qubit measurements to measurement results (e.g., a probability that a qubit was in particular qubit state and/or the like probability that a set of qubits was in a particular (combined) quantum state as a result of the performance of the quantum circuit and/or program by the quantum computer). Thus, various embodiments provide improvements to the fields of quantum computing and quantum measurement result determination and interpretation. Various embodiments provide further improvements by providing methods, apparatuses, systems, computer program products, and/or the like, which make use of conventional qubit classification methods (e.g., linear discriminators) as a component thereof, to provide significantly improved measurement quality (compared to use of conventional qubit classification methods alone).

Various embodiments are described herein as determining a measurement result of one or more qubits. As should be understood, various embodiments may also include determining a measurement result of one or more qutrits (a three-state quantum system) and/or one or more qudits (a d-state quantum system, where d is a natural number that is at least two).

### Example System Architecture

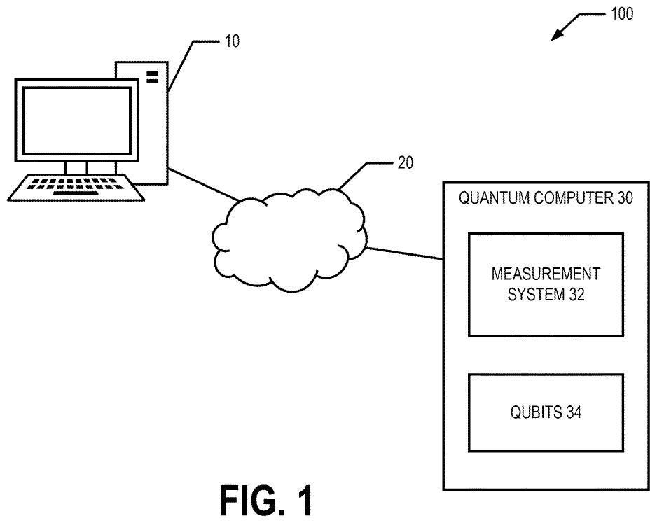

FIG. 1 provides a block diagram of an example system 100 that maybe used in various embodiments. In various embodiments, the system 100 comprises a classical computing entity 10 and a quantum computer 30.

The quantum computer 30 comprises qubits 34 and a measurement system 32 configured to measure the respective quantum states of the qubits 34. In various embodiments, the quantum computer 30 is configured to perform quantum logic operations on one or more qubits 34 thereof. For example, the quantum computer 30 may perform a quantum circuit and/or program by performing the sequence of quantum logic operations indicated by the quantum circuit and/or program on the one or more qubits 34. The quantum computer 30 may then use the measurement system 32 to measure the respective quantum states of the one or more qubits 34 as a result of the performance of the quantum circuit and/or program by the quantum computer 30.

In various embodiments, the quantum computer 30 is in communication with a classical computing entity 10 via one or more wired or wireless networks 20 and/or via direct wired and/or wireless communications. For example, the classical computing entity 10 may be configured to provide the quantum circuit and/or program to the quantum computer 30 and receive measured values corresponding to the qubit measurements indicating the quantum states of the one or more qubits 34 as a result of the performance of the quantum circuit and/or program by the quantum computer 30.

In various embodiments, the quantum computer 30 performs the quantum circuit and/or program multiple times (e.g., a plurality of times) and performs qubit measurements for each instance of the performance of the quantum circuit and/or program. The classical computing entity 10 receives the qubit measurements and, using a distribution function discriminator, determines a measurement result for the quantum circuit and/or program. An indication of the measurement result is provided (e.g., stored in classical memory for later use, provided in a human-perceivable manner, provided as input to a program or application operating on the classical computing entity or another classical computing device).

### Example Operation of a Classical Computing Entity to Determine a Distribution Function

In various embodiments, a distribution function of a plurality of qubit measurements is determined. In various embodiments, the distribution function is a cumulative distribution function. A cumulative distribution function is a function that provides the probability that a value that is randomly selected from a distribution of values described by a given distribution will have a value that is less than or equal to a particular value.

In various embodiments, a distribution function is determined for a plurality of qubit measurements corresponding to a first qubit state. For example, a qubit may be prepared in a first qubit state (e.g., |0 [symbol] ) through execution of a first qubit state preparation quantum circuit and/or program. The quantum state of the qubit may then be measured to determine a qubit measurement. This process may be repeated a plurality of times (in series or in parallel) to generate a plurality of qubit measurements corresponding to the first qubit state. The plurality of qubit measurements corresponding to the first qubit state may then be analyzed, processed, and/or the like to determine and/or generate a distribution function corresponding to the first qubit state.

In various embodiments, a distribution function is determined for a plurality of qubit measurements corresponding to a second qubit state. For example, a qubit may be prepared in a second qubit state (e.g., |1 [symbol] ) through execution of a second qubit state preparation quantum circuit and/or program. The quantum state of the qubit may then be measured to determine a qubit measurement. This process may be repeated a plurality of times (in series or in parallel) to generate a plurality of qubit measurements corresponding to the second qubit state. The plurality of qubit measurements corresponding to the second qubit state may then be analyzed, processed, and/or the like to generate a distribution function corresponding to the second qubit state.

In various embodiments, a distribution function is determined for a plurality of qubit measurements corresponding to the quantum state of a qubit as a result of the performance of an arbitrary quantum circuit and/or program. For example, a quantum calculation may be performed through the performance of the quantum circuit and/or program. The quantum state of the qubit may then be measured to determine a qubit measurement. This process may be repeated a plurality of times (in series or in parallel) to generate a plurality of qubit measurements corresponding to the quantum state of the qubit as a result of the performance of the quantum circuit and/or program. The plurality of qubit measurements corresponding to the quantum state of the qubit as a result of the performance of the quantum circuit and/or program may then be analyzed, processed, and/or the like to generate a distribution function corresponding to the quantum state of the qubit as a result of the performance of the quantum circuit and/or program.

In various embodiments, the plurality of qubit measurements comprises 1,000 to 50,000 qubit measurements. In an example embodiment, the plurality of qubit measurements comprises 5,000 to 20,000 qubit measurements. In various embodiments, the plurality of qubit measurements may include fewer than 1,000 qubit measurements or more than 50,000 qubit measurements, as appropriate for the application.

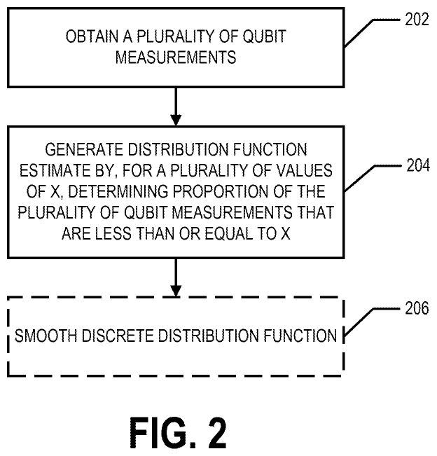

FIG. 2 provides a flowchart illustrating various processes, procedures, operations, and/or the like for determining the distribution function of a plurality of qubit measurements. Starting at step 202, a plurality of qubit measurements is obtained. For example, the classical computing entity 10 may receive and/or access (e.g., read from memory) a plurality of qubit measurements.

For example, the quantum computer 30 may generate a plurality of qubit measurements and provide (e.g., transmit) the plurality of qubit measurements (e.g., individually, in multiple groups, and/or as a whole) such that the classical computing entity 10 receives the plurality of qubit measurements. The classical computing entity 10 may store the plurality of qubit measurements to memory (e.g., for later use) and/or may determine the distribution function for the plurality of qubit measurements upon receiving the plurality of qubit measurements.

At step 204, the classical computing entity 10 generates a distribution function estimate. In various embodiments, the classical computing entity 10 generates the distribution function estimate by, for a plurality of values x, determining the proportion of the qubit measurement values that are less than or equal to x. For example, the distribution function estimate may be a discrete estimate or approximation of the distribution function corresponding to the plurality of qubit measurements.

In an example embodiment, for a particular value x, the value of the distribution function estimate \hat{P}_{E}(X≤x) is determined by

$${\hat{P}}_{E} ( X \leq x ) = \frac{1}{k} {\sum }_{i = 0}^{k} I ( {t}_{i} \leq x ) ,$$

where k is the number of qubit measurements in the plurality of qubit measurements, tᵢ runs through each qubit measurement of the set of qubit measurements, I(q) is an indicator function which gives the value 1 when q is true (e.g., tᵢ is less than or equal to x) and give the value 0 when q is false (e.g., tᵢ is not less than or equal to x). In an example embodiment, a binary search is implemented to compute the sum. This sum is determined for a plurality of particular values x to generate a piece-wise defined distribution function estimate.

At step 206, the classical computing entity 10 may smooth the distribution function estimate. For example, in various embodiments, a linear interpolation and/or other smoothing function may be used to generate a continuous distribution function based on the empirically determined distribution function estimate. For example, the distribution function \hat{P}(X≤x) corresponding to a plurality of qubit measurements is the result of applying a smoothing function to the empirically determined distribution function estimate \hat{P}_{E}(X≤x), in an example embodiment.

In various embodiments, each qubit measurement includes an in-phase component and a quadrature component. For example, in various embodiments, a qubit measurement is not merely a scalar value, but rather is a two-component vector value. In various embodiments, a distribution function is determined and/or generated for the in-phase component of the plurality of qubit measurements and a distribution function is determined and/or generated for the quadrature component of the plurality of qubit measurements. For example, the in-phase components of the plurality of qubit measurements may be treated independently of the quadrature components of the plurality of qubit measurements, and vice versa. For example, in various embodiments, the in-phase component distribution function and the quadrature component distribution function are independent of one another. The distribution function \hat{P}(X≤x) corresponding to a plurality of qubit measurements may then be determined and/or generated as the product of the distribution function for the in-phase component of the plurality of qubit measurements \hat{P}_{I}(X≤x) and the distribution function for the quadrature component of the plurality of qubit measurements \hat{P}_{Q}(X≤x) (e.g., \hat{P}(X≤x)=\hat{P}_{I}(X≤x)·\hat{P}_{Q}(X≤x)).

### Example Operation of a Classical Computing Entity to Use a Distribution Function Discriminator to Determine and Provide a Measurement Result for a Single Qubit

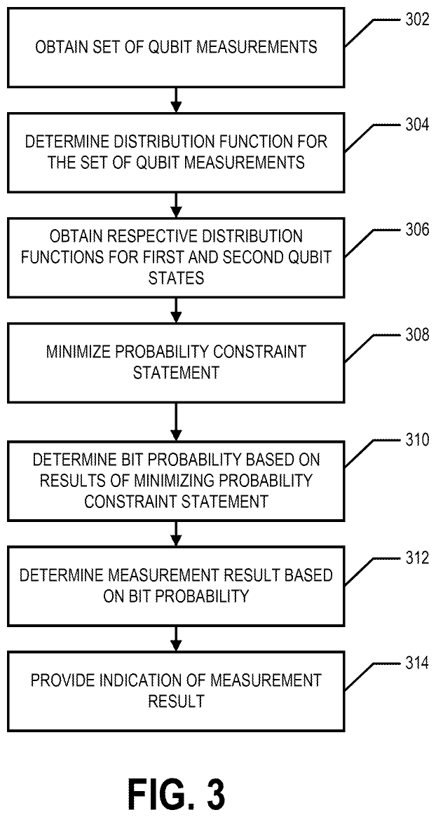

FIG. 3 provides a flowchart illustrating various processes, procedures, operations, and/or the like performed by a distribution function discriminator to determine and provide measurement results for a single qubit measurement. For example, a single qubit may be measured to determine the result of the performance of a quantum circuit and/or program. The quantum circuit and/or program may be performed a plurality of times with the quantum state of the qubit as a result of the performance of the quantum circuit and/or program being measured each time. Thus, a set of qubit measurements corresponding to the performance of the quantum circuit and/or program may be generated. The set of qubit measurements corresponding to the performance of the quantum circuit and/or program comprises a plurality of qubit measurements corresponding to the quantum state of the qubit as a result of the performance of the quantum circuit and/or program. As noted above, in various embodiments, each qubit measurement includes a respective in-phase component and a respective quadrature component.

Starting at step 302, a set of qubit measurements corresponding to the performance of the quantum circuit and/or program is obtained. For example, the distribution function discriminator operating on the classical computing entity 10 may receive and/or access (e.g., read from memory) a plurality of qubit measurements corresponding to the performance of the quantum circuit and/or program. For example, the set of qubit measurements may be received via an application program interface (API) or other appropriate interface of the distribution function discriminator that is configured to enable communication with a qubit measurement database, quantum computer 30, and/or the like.

For example, the quantum computer 30 may generate a set of qubit measurements that includes a plurality of qubit measurements generated as a result of performing the quantum circuit and/or program a plurality of times and provide (e.g., transmit) the set of qubit measurements (e.g., individually, in multiple groups, and/or as a whole set) such that the classical computing entity 10 receives the set of qubit measurements corresponding to the performance of the quantum circuit and/or program. The classical computing entity 10 may store the plurality of qubit measurements corresponding to the performance of the quantum circuit and/or program to memory (e.g., for later use) and/or may determine the distribution function for the set of qubit measurements corresponding to the performance of the quantum circuit and/or program upon receiving the set of qubit measurements.

At step 304, the distribution function discriminator operating on the classical computing entity 10 determines a distribution function for the set of qubit measurements corresponding to the performance of the quantum circuit and/or program. For example, the classical computing entity may use the set of qubit measurements corresponding to the performance of the quantum circuit and/or program to perform step 204 and possibly step 206 to generate the distribution function for the set of qubit measurements corresponding to the performance of the quantum circuit and/or program. In various embodiments, the classical computing entity 10 may determine a distribution function for the set of qubit measurements corresponding to the performance of the quantum circuit and/or program using various other distribution function determination techniques, as appropriate for the application.

At step 306, the distribution function discriminator operating on the classical computing entity 10 obtains a distribution function corresponding to the first qubit state and a distribution function corresponding to the second qubit state for the quantum computer 30. In an example embodiment, the respective distribution functions corresponding to the first qubit state and the second qubit state are accessed (e.g., read from a classical memory) and/or generated/determined. For example, in an example embodiment, the respective distribution functions corresponding to the first qubit state and the second qubit state are accessed and/or received via an API or other appropriate interface of the distribution function discriminator.

For example, the classical computing entity 10 (and/or another classical computing device) may perform steps 202-206 for a plurality of qubit measurements (generated by the quantum computer 30) corresponding to the first qubit state to determine and/or generate a distribution function corresponding to the first qubit state. The distribution function corresponding to the first qubit state may then be stored to memory (e.g., a classical memory of the classical computing entity) for later use in processing and/or analyzing qubit measurements captured and/or generated by the quantum computer 30. For example, the classical computing entity 10 (and/or another classical computing device) may perform steps 202-206 for a plurality of qubit measurements (generated by the quantum computer 30) corresponding to the second qubit state to determine and/or generate a distribution function corresponding to the second qubit state. The distribution function corresponding to the second qubit state may then be stored to memory (e.g., a classical memory of the classical computing entity) for later use in processing and/or analyzing qubit measurements captured and/or generated by the quantum computer 30.

In various embodiments, the same hardware (e.g., quantum computer 30) is used to generate the plurality of qubit measurements corresponding to the first qubit state and used to determine/generate the distribution function corresponding to the first qubit state, the plurality of qubit measurements corresponding to the second qubit state and used to determine/generate the distribution function corresponding to the second qubit state, and the set of qubit measurements corresponding to performance of the quantum circuit and/or program and used to determine/generate the distribution function corresponding to performance of the quantum circuit and/or program. In various embodiments, the distribution function corresponding to the first qubit state and the distribution function corresponding to the second qubit state for the quantum computer 30 are generated and/or determined periodically, regularly, and/or in response to one or more parameters of the quantum computer 30 being modified and/or updated. For example, the distribution function corresponding to the first qubit state and the distribution function corresponding to the second qubit state for the quantum computer 30 may be generated and/or determined as part of a regular, periodic, and/or triggered calibration of the quantum computer 30. For example, the noise profile of a first quantum computer may differ from that of another quantum computer. Additionally, the noise profile of the quantum computer 30 may change over time, with changes in operating conditions and/or operating parameters, and/or the like. Thus, in various embodiments the plurality of qubit measurements corresponding to the first qubit state, the plurality of qubit measurements corresponding to the second qubit state, and the set of qubit measurements corresponding to the performance of the quantum circuit and/or program are captured and/or generated in a manner that the noise profile is approximately and/or substantially the same during the capturing and/or generating of the plurality of qubit measurements corresponding to the first qubit state, the plurality of qubit measurements corresponding to the second qubit state, and the set of qubit measurements corresponding to the performance of the quantum circuit and/or program.

At step 308, a probability constraint statement is minimized. For example, the distribution function discriminator operating on the classical computing entity 10 determines a probability parameter α that minimizes a probability constraint statement. In various embodiments the probability constraint statement is similar to a loss function that quantifies the difference between a predicted probability parameter α and the probability parameter that is encoded by the set of qubit measurements corresponding to the performance of the quantum circuit and/or program. In an example embodiment, the probability constraint statement is ∥(αF(x)+(1−α)G(x))−H(x)∥, where F(x) is the distribution function corresponding to the first qubit state (e.g., \hat{P}(X≤x)), G(x) is the distribution function corresponding to the second qubit state, and H(x) is the distribution function corresponding to the performance of the quantum circuit and/or program. In various embodiments, the probability constraint statement is minimized under the constraint that the probability parameter is within an allowed range. In various embodiments, the allowed range is the inclusive range of 0 to 1 (e.g., 0≤α≤1). In an example embodiment, a least squares regression technique is used to minimize the probability constraint statement. In various other embodiments, various minimization techniques may be used to determine the value of probability parameter α (within an allowed range) that minimizes the probability constraint statement.

At step 310, the bit probability corresponding to the performance of the quantum circuit and/or program is determined based on the results of minimizing the probability constraint statement. For example, the distribution function discriminator operating on the classical computing entity 10 determines the bit probability corresponding to the performance of the quantum circuit and/or program based on the results of minimizing the probability constraint statement. For example, in an example embodiment, the bit probability is the probability that the qubit is in a first qubit state as a result of the performance of the quantum circuit and/or program. In an example embodiment, the bit probability is equal to and/or a function of the probability parameter α. For example, when the probability constraint statement is ∥(αF(x)+(1−α)G(x))−H(x)∥, the probability that the qubit is in the first qubit state as a result of the performance of the quantum circuit and/or program is equal to the probability parameter α. Based on the probability constraint statement, an appropriate relationship between the bit probability and the probability parameter α is used to determine the bit probability (e.g., the probability that the qubit is in a first qubit state as a result of the performance of the quantum circuit and/or program).

At step 312, the distribution function discriminator operating on the classical computing entity 10 determines a measurement result based on the bit probability. In various embodiments, the measurement result is the probability that the quantum state of the qubit is the first qubit state and/or the second qubit state as a result of the performance of the quantum circuit and/or program. For example, in an example embodiment, determining the measurement result comprises determining the probability that the qubit is in the first qubit state as a result of the performance of the quantum circuit and/or program. In various embodiments, the probability that the qubit is in the first qubit state as a result of the performance of the quantum circuit and/or program is the bit probability. In various embodiments, determining the measurement result comprises determining the probability that the qubit is in the second qubit state as a result of the performance of the quantum circuit and/or program. In various embodiments, the probability that the qubit is in the second qubit state as a result of the performance of the quantum circuit and/or program is one minus the bit probability. In various embodiments, determining the measurement result comprises (a) determining the probability that the qubit is in the first qubit state as a result of the performance of the quantum circuit and/or program and (b) determining the probability that the qubit is in the second qubit state as a result of the performance of the quantum circuit and/or program.

At step 314, the distribution function discriminator operating on the classical computing entity 10 provides an indication of the measurement result. In various embodiments, the indication of the measurement result is one or more bit strings that provide the measurement result. In an example embodiment, the indication of the measurement result is a graphical representation of the measurement result (e.g., a histogram, pie chart, infographic, and/or the like). In various embodiments, the indication of the measurement result is provided in a human perceivable manner (e.g., via display or speaker), stored in classical memory for future use, and/or provided as input (e.g., via an API call or other appropriate interface of the distribution function discriminator) to a program or application operating on the classical computing entity and/or another classical computing device. For example, the indication of the measurement result may be provided such that the result of the quantum calculation corresponding to performance of the quantum circuit and/or program is determined and/or interpreted, as appropriate for the application.

As noted above, in various embodiments, the measurement results are qutrit or qudit measurement results rather than qubit measurement results. For example, the measurement results may be for a quantum system having three or d (e.g., a natural number of at least two) quantum states. As should be understood, a qubit is a qudit with d=2 and a qutrit is a qudit with d=3. In the general case of a qudit with d quantum/qudit states, respective distribution functions are determined for each of the d quantum/qudit states and the probability constraint statement is expanded to include weighted distribution functions for each of the d quantum/qudit states (e.g., ∥(ΣᵢαᵢFᵢ(x))−H(x)∥ with constraint Σᵢαᵢ=1, where αᵢ indicates the probability that the quantum system was in the ith qudit state and Fᵢ(x) is the distribution function corresponding to the ith qudit state, with the index i running through the d quantum/qudit states).

### Example Operation of a Classical Computing Entity to Use a Distribution Function Discriminator to Determine and Provide a Measurement Result for Multiple Qubits

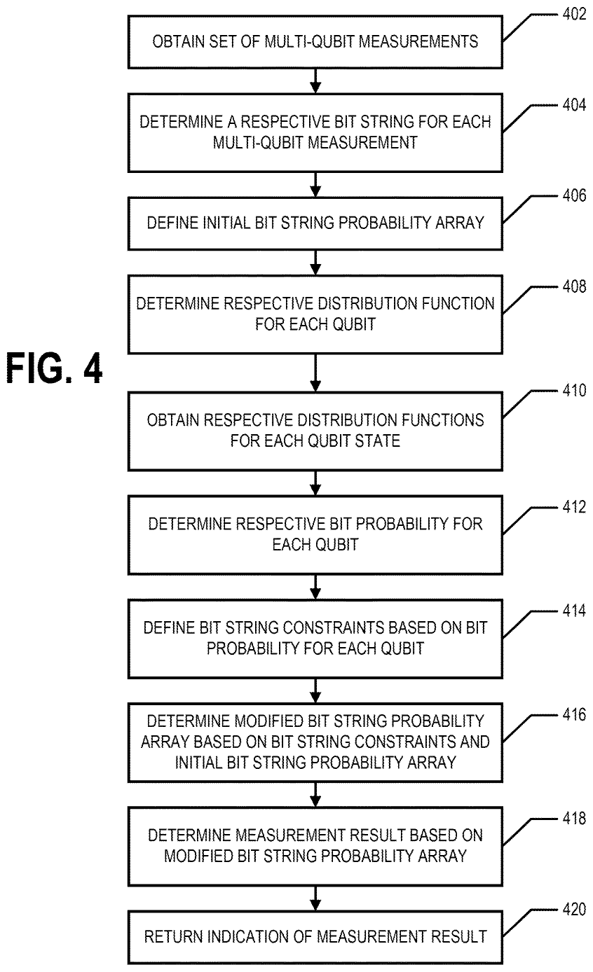

FIG. 4 provides a flowchart illustrating various processes, procedures, operations, and/or the like performed by a distribution function discriminator operating on a classical computing entity 10 to determine and/or provide a measurement result based on a set of multi-qubit measurements. For example, in various embodiments, the quantum computer 30 comprises a plurality of qubits (e.g., n qubits, where n is a positive integer) that are measured to determine the result of performing the quantum circuit and/or program by the quantum computer.

For example, the quantum computer 30 may perform the quantum circuit and/or program and then measure the quantum state of a plurality of qubits of the quantum computer to generate a multi-qubit measurement. The quantum computer 30 may perform the quantum circuit and/or program a plurality of times to generate a plurality of multi-qubit measurements.

Each multi-qubit measurement includes a qubit measurement of a respective quantum state of each of the n qubits. For example, the result of the quantum circuit and/or program is provided by a quantum state of the plurality of qubits. For example, the result of the quantum circuit and/or program may be a bit string comprising n bits with each bit being the qubit state of a respective qubit of n qubits as a result of the performance of the quantum circuit and/or program, where n is a positive integer. In various embodiments, each qubit measurement includes an in-phase component and a quadrature component.

At step 402, the distribution function discriminator operating on the classical computing entity 10 obtains a set of multi-qubit measurements. For example, the distribution function discriminator operating on the classical computing entity 10 may receive and/or access (e.g., read from memory) a plurality of multi-qubit measurements corresponding to the performance of the quantum circuit and/or program. For example, the set of multi-qubit measurements may be received via an application program interface (API) or other appropriate interface of the distribution function discriminator that is configured to enable communication with a qubit measurement database, quantum computer 30, and/or the like.

For example, the quantum computer 30 may generate a set of multi-qubit measurements that includes a plurality of multi-qubit measurements generated as a result of performing the quantum circuit and/or program a plurality of times and provide (e.g., transmit) the set of multi-qubit measurements (e.g., individually, in multiple groups, and/or as a whole set) such that the classical computing entity 10 receives the set of multi-qubit measurements corresponding to the performance of the quantum circuit and/or program. The classical computing entity 10 may store the set of multi-qubit measurements corresponding to the performance of the quantum circuit and/or program to memory (e.g., for later use) and/or may determine the measurement results for the set of multi-qubit measurements corresponding to the performance of the quantum circuit and/or program upon receiving the set of multi-qubit measurements. In various embodiments, each multi-qubit measurement of the set of multi-qubit measurements includes a plurality of qubit measurements (e.g., n qubit measurements) corresponding to an instance of the performance of the quantum circuit and/or program by the quantum computer, with each of the plurality of qubit measurements corresponding to a respective qubit.

At step 404, the distribution function discriminator operating on the classical computing entity 10 determines a bit string for each multi-qubit measurement. For example, for each multi-qubit measurement, the distribution function discriminator analyzes each respective qubit measurement of the n qubit measurements of the respective multi-qubit measurement to determine a respective qubit state. Each of the n respective qubit states provides a bit (e.g., 0 or 1, where the 0 indicates that the respective qubit state is a first qubit state (e.g., |0 [symbol] ) and the 1 indicates that the respective qubit state is a second qubit state (e.g., |1 [symbol] )). Thus, the distribution function determines a plurality of length n bit strings (e.g., a bit string consisting of n bits) that each correspond to a respective multi-qubit measurement of the set of multi-qubit measurements.

In an example embodiment, the distribution function discriminator causes one or more linear discriminators to analyze each qubit measurement of a respective multi-qubit measurement to determine the respective quantum states of the qubits. For example, the distribution function discriminator causes one or more linear discriminators to analyze each qubit measurement of a respective multi-qubit measurement to determine a bit string of length n where each bit indicates a respective quantum state of a respective qubit of the n qubits. In various embodiments, the one or more linear discriminators are machine learning-trained models configured to classify and/or determine a quantum state of a qubit (e.g., a first qubit state or a second qubit state) based on a respective qubit measurement. In an example embodiment, each linear discriminator is trained to determine a respective quantum state based on a single qubit measurement (e.g., independent of any other qubit measurements of the respective multi-qubit measurement or any other qubit measurements corresponding to the respective qubit).

At step 406, the distribution function discriminator operating on the classical computing entity 10 determines an initial bit string probability array. In various embodiments, the initial bit string probability array is determined by determining the frequency with which each unique length n bit string appears in the plurality of length n bit strings determined at step 404. In various embodiments, the initial bit string probability array provides the respective probabilities that a length n bit string randomly selected from the plurality of length n bit strings determined at step 404 will be a respective unique length n bit string.

For example, in a scenario where each multi-qubit measurement includes three qubits (e.g., n=3), the unique bit strings are [000], [001], [010], [011], [100], [101], [110], and [111]. In this example scenario, the set of multi-qubit measurements includes ten multi-qubit measurements, and the plurality of length n bit strings includes [001], [010], [0011], [010], [110], [011], [001], [011], [010], and [011]. Thus, the probability that a randomly selected bit string from the plurality of length n bit strings is the unique bit string [000], [100], [101], or [111] are each zero. The probability that a randomly selected bit string from the plurality of length n bit strings is the unique bit string [001] is 0.2. The probability that a randomly selected bit string from the plurality of length n bit strings is the unique bit string [010] is 0.3. The probability that a randomly selected bit string from the plurality of length n bit strings is the unique bit string [011] is 0.4. The probability that a randomly selected bit string from the plurality of length n bit strings is the unique bit string [110] is 0.1. Thus, in this example, the initial bit string probability array is [0, 0.2, 0.3, 0.4, 0, 0, 0.1, 0] corresponding to the unique bit strings [000], [001], [010], [011], [100], [101], [110], and [111].

At step 408, the distribution function discriminator operating on the classical computing entity 10 determines respective distribution functions for each qubit. For example, the set of multi-qubit measurements comprises a respective set of (single) qubit measurements for each qubit of the plurality of qubits. For example, the set of multi-qubit measurements comprises a set of qubit measurements corresponding to a first qubit, a set of qubit measurements corresponding to a second qubit, and so on for each of the n qubits. Based on the set of (single) qubit measurements for a respective qubit of the plurality of qubits, the distribution function discriminator determines a respective distribution function. In various embodiments, the respective distribution function is a respective cumulative distribution function. For example, the distribution function discriminator may perform steps 204-206 based on the respective set of qubit measurements for a respective qubit of the plurality of qubits for each qubit of the plurality of qubits.

At step 410, the distribution function discriminator operating on the classical computing entity 10 obtains a distribution function corresponding to the first qubit state and a distribution function corresponding to the second qubit state for the quantum computer 30. In an example embodiment, the respective distribution functions corresponding to the first qubit state and the second qubit state are accessed (e.g., read from a classical memory) and/or generated/determined. For example, in an example embodiment, the respective distribution functions corresponding to the first qubit state and the second qubit state are accessed and/or received via an API or other appropriate interface of the distribution function discriminator.

For example, the classical computing entity 10 (and/or another classical computing device) may perform steps 202-206 for a plurality of qubit measurements (generated by the quantum computer 30) corresponding to the first qubit state to determine and/or generate a distribution function corresponding to the first qubit state. The distribution function corresponding to the first qubit state may then be stored to memory (e.g., a classical memory of the classical computing entity) for later use in processing and/or analyzing qubit measurements captured and/or generated by the quantum computer 30. For example, the classical computing entity 10 (and/or another classical computing device) may perform steps 202-206 for a plurality of qubit measurements (generated by the quantum computer 30) corresponding to the second qubit state to determine and/or generate a distribution function corresponding to the second qubit state. The distribution function corresponding to the second qubit state may then be stored to memory (e.g., a classical memory of the classical computing entity) for later use in processing and/or analyzing qubit measurements captured and/or generated by the quantum computer 30.

In various embodiments, the same hardware (e.g., quantum computer 30) is used to generate the plurality of qubit measurements corresponding to the first qubit state and used to determine/generate the distribution function corresponding to the first qubit state, the plurality of qubit measurements corresponding to the second qubit state and used to determine/generate the distribution function corresponding to the second qubit state, and the set of multi-qubit measurements corresponding to performance of the quantum circuit and/or program and used to determine/generate the respective distribution functions corresponding to performance of the quantum circuit and/or program. In various embodiments, the distribution function corresponding to the first qubit state and the distribution function corresponding to the second qubit state for the quantum computer 30 are generated and/or determined periodically, regularly, and/or in response to one or more parameters of the quantum computer 30 being modified and/or updated. For example, the distribution function corresponding to the first qubit state and the distribution function corresponding to the second qubit state for the quantum computer 30 may be generated and/or determined as part of a regular, periodic, and/or triggered calibration of the quantum computer 30. For example, the noise profile of a first quantum computer may differ from that of another quantum computer. Additionally, the noise profile of the quantum computer 30 may change over time, with changes in operating conditions and/or operating parameters, and/or the like. Thus, in various embodiments the plurality of qubit measurements corresponding to the first qubit state, the plurality of qubit measurements corresponding to the second qubit state, and the set of multi-qubit measurements corresponding to the performance of the quantum circuit and/or program are captured and/or generated in a manner that the noise profile is approximately and/or substantially the same during the capturing and/or generating of the plurality of qubit measurements corresponding to the first qubit state, the plurality of qubit measurements corresponding to the second qubit state, and the set of multi-qubit measurements corresponding to the performance of the quantum circuit and/or program.

At step 412, a respective bit probability is determined for each qubit of the plurality of qubits. For example, the distribution function discriminator operating on the classical computing entity 10 determined a respective bit probability for each qubit of the plurality of qubits based on the respective distribution function corresponding to the respective qubit, the distribution function corresponding to the first qubit state, and the distribution function corresponding to the second qubit state.

In various embodiments, to determine a respective bit probability for a respective qubit, a probability constraint statement is minimized. For example, the distribution function discriminator operating on the classical computing entity 10 determines a probability parameter ai that minimizes a probability constraint statement corresponding to the jth qubit. In various embodiments the probability constraint statement is similar to a loss function that quantifies the difference between a predicted probability parameter αⱼ and the probability parameter that is encoded by the set of qubit measurements for the jth qubit and corresponding to the performance of the quantum circuit and/or program. In an example embodiment, the probability constraint statement is ∥(αⱼF(x)+(1−αⱼ)G(x))−Hⱼ(x) where F(x) is the distribution function corresponding to the first qubit state, G(x) is the distribution function corresponding to the second qubit state, and H(x) is the distribution function for the jth qubit and corresponding to the performance of the quantum circuit and/or program. In various embodiments, the probability constraint statement is minimized under the constraint that the probability parameter is within an allowed range. In various embodiments, the allowed range is the inclusive range of 0 to 1 (e.g., 0≤αⱼ≤1). In an example embodiment, a least squares regression technique is used to minimize the probability constraint statement. In various other embodiments, various minimization techniques may be used to determine the value of probability parameter αⱼ (within an allowed range) that minimizes the probability constraint statement.

In various embodiments, the distribution function discriminator operating on the classical computing entity 10 determines a bit probability for the jth qubit corresponding to the performance of the quantum circuit and/or program based on the results of minimizing the probability constraint statement corresponding to the jth qubit. For example, in an example embodiment, the bit probability for the jth qubit is the probability that the jth qubit is in a first qubit state as a result of the performance of the quantum circuit and/or program. In an example embodiment, the bit probability for the jth qubit is equal to and/or a function of the probability parameter αⱼ. For example, when the probability constraint statement is ∥(αⱼF(x)+(1−αⱼ)G(x))−Hⱼ(x)∥, the probability that the jth qubit is in the first qubit state as a result of the performance of the quantum circuit and/or program is equal to the probability parameter αⱼ. Based on the probability constraint statement, an appropriate relationship between the bit probability and the probability parameter αⱼ for the jth qubit is used to determine the bit probability for the jth qubit (e.g., the probability that the jth qubit is in a first qubit state as a result of the performance of the quantum circuit and/or program). A respective bit probability is determined for each qubit of the plurality of qubits based on the respective distribution function, in various embodiments.

At step 414, the distribution function discriminator operating on the classical computing entity 10 defines bit string constraints based on the respective bit probabilities determined for each qubit. For example, the distribution function discriminator determines that the bit probability for a first qubit is a first probability. Thus, the sum of the probabilities of each unique bit string where the first qubit is in the first qubit state should be equal to the first probability. Equivalently, the sum of the probabilities of each unique bit string where the first qubit is in the second qubit state should be equal to one minus the first probability. Additionally, the bit string constraint that the sum of the probability of each of the unique bit strings is equal to 1.0 is defined, in an example embodiment. Thus, n+1 bit string constraints are defined, in an example embodiment.

For example, continuing the example with three qubits from above, four unique bit strings correspond to the first qubit being in the first qubit state ([000], [001], [010], [011]). If the first qubit is determined to have a bit probability of 1.0, indicating that the probability that the first qubit is in the first qubit state is 1.0, then the probability of each of the unique bit strings with the first qubit in the first qubit state should sum to 1.0. For example, the sum of (a) the probability that the outcome of performing the quantum circuit and/or program is [000], (b) the probability that the outcome of performing the quantum circuit and/or program is [001], (c) the probability that the outcome of performing the quantum circuit and/or program is [010], and (d) the probability that the outcome of performing the quantum circuit is [011] is 1.0, in this example. Equivalently, the sum of (a) the probability that the outcome of performing the quantum circuit and/or program is [100], (b) the probability that the outcome of performing the quantum circuit and/or program is [101], (c) the probability that the outcome of performing the quantum circuit and/or program is [110], and (d) the probability that the outcome of performing the quantum circuit is [111] is 1.0 minus 1.0, or 0.0, in this example. Similarly, if the second qubit is determined to have a bit probability of 0.1, then the sum of the respective probabilities of the unique bit strings [000], [001], [100], and [101] is 0.1. Continuing with this example, if the third qubit is determined to have a bit probability of 0.4, then the sum of the respective probabilities of unique bit strings [000], [010], [100], and [110] are 0.4. Additionally, the bit string constraint that the sum of the respective probabilities of all of the unique bit strings (e.g., the sum of the respective probabilities of [000], [001], [010], [011], [100], [101], [110], and [111]) is equal to 1.0 is defined.

At step 416, the distribution function discriminator operating on the classical computing entity 10 determines a modified bit string probability array based on the bit string constraints and the initial bit string probability array. For example, the initial bit string probability array is modified, corrected, and/or updated based on the bit string constraints to determine and/or generate a modified bit string probability array, in an example embodiment.

In an example embodiment, the modified bit string probability array is determined and/or generated by minimizing a probability array difference statement that provides an indication between the initial bit string probability array and a constrained bit string probability array. The constrained bit string probability array is an array of length n that satisfies each of the n+1 bit string constraints. In an example embodiment, the probability array difference statement takes the form ∥\hat{α}^{I}−α^{C}∥, where \hat{α}^{I} is the initial bit string probability array and \hat{α}^{C} is the constrained bit string probability array that satisfies each bit string constraint of the n+1 bit string constraints. The constrained bit string probability array that minimizes the probability array difference statement is extracted as the modified bit string probability array. In an example embodiment, a least squares regression technique is used to determine a constrained bit string probability array that satisfies each of the bit string constraints and minimizes the probability array difference statement.

For example, continuing with the above example including three qubits, the initial bit string probability array was determined to be [0, 0.2, 0.3, 0.4, 0, 0, 0.1, 0]. However, this set of bit string probabilities is not in accordance with the example bit string constraints, which dictates that the sum of the respective probabilities of bit strings [100], [101], [110], [111] is 0.0, in this example. In particular, the sum of the probabilities of these four-bit strings in the initial bit string probability array (the sum of the last four array elements) is 0.1. However, a constrained bit string probability array may be constructed as [0, 0.1, 0.4, 0.5, 0, 0, 0, 0], which satisfies the constraints that the sum of the first four elements of the constrained bit string array be equal to 1.0, the sum of the first, second, fifth, and sixth elements of the constrained bit string array be equal to 0.1, the sum of the first, third, fifth, and seventh elements of the constrained bit string array be equal to 0.4, and the sum of all of the elements of the constrained bit string array be equal to 1.0. If the provided example constrained bit string probability array minimizes the probability array difference statement, then it is determined that there is a 10% probability that the result of performing the quantum circuit and/or program corresponds to bit string [001], 40% probability that the result of performing the quantum circuit and/or program corresponds to bit string [010], and a 50% probability that the result of performing the quantum circuit and/or program corresponds to bit string [011].

At step 418, the distribution function discriminator operating on the classical computing entity 10 determines a measurement result based on the modified bit string probability array. In various embodiments, the measurement result is the probability that the quantum states of the plurality of qubits as a result of the performance of the quantum circuit and/or program is a first bit string. In various embodiments, the measurement result is the probability that each unique bit string of length n represents the quantum states of the n qubits as a result of the performance of the quantum circuit and/or program. For example, in an example embodiment, the measurement result is the modified bit string probability array. In various embodiments, determining the measurement result comprises identifying a subset of the unique bit strings of length n that are possible results and/or the most likely result of the performance of the quantum circuit and/or program.

At step 420, the distribution function discriminator operating on the classical computing entity 10 provides an indication of the measurement result. In various embodiments, the indication of the measurement result is one or more bit strings that provide the measurement result. For example, one or more of the unique bit strings of length n that are most likely to be the result of the performance of the quantum circuit and/or program may be provided as the indication of the measurement result. In another example, the modified bit string probability array may be provided as the indication of the measurement result. In an example embodiment, the indication of the measurement result is a graphical representation of the measurement result (e.g., a histogram, pie chart, infographic, and/or the like). In various embodiments, the indication of the measurement result is provided in a human perceivable manner (e.g., via display or speaker), stored in classical memory for future use, and/or provided as input (e.g., via an API call or other appropriate interface of the distribution function discriminator) to a program or application operating on the classical computing entity and/or another classical computing device. For example, the indication of the measurement result may be provided such that the result of the quantum calculation corresponding to performance of the quantum circuit and/or program is determined and/or interpreted, as appropriate for the application.

As should be understood, respective distribution functions for each of d quantum/qudit states may be determined for each qudit of a multiple qudit system. The respective measurement result probabilities (e.g., the probability for each of the d quantum/qudit states) for each qudit may be determined and used to define a set of bit string constraints. A modified bit string probability array may then be determined based on the bit string constraints and the initial bit string. Thus, various embodiments provide for determining a measurement result for a multiple qudit system, where the qudits are defined by d quantum/qudit states.

### Technical Advantages

Quantum computing is expected to significantly out-perform classical computing on many hard problems due to quantum mechanical effects such as entanglement and superposition. While a memory component of a classical computer (e.g., a bit) can only be in one possible state at a time, a memory component of a quantum computer (e.g., a qubit) can be in an arbitrary combination or superposition of states at the same time. Unfortunately, quantum computing also introduces a significant level of noise and uncertainty compared to classical computing. Moreover, the result of measuring a quantum state of a qubit of a quantum computer forces the arbitrary state of the qubit to one known state with some probability. Thus, to understand the result of performing a quantum circuit or program, the quantum circuit or program may be executed multiple times and the qubit measurement may be performed each time.

There are various sources of noise (errors) in quantum computers including (a) initial state preparation, (b) actual computation, and (c) measurement of results. Moreover, the noise or error introduced into the qubit measurements may be dependent on the quantum state of the qubit. As a result, the noise or error cannot be simply filtered out of the qubit measurements. Therefore, technical problems exist regarding how interpret the measurement results of a quantum computer.

Various embodiments provide technical solutions to these technical problems. In particular, various embodiments employ distribution function descriptions of a plurality of qubit measurements to determine the underlying probability that a qubit or a set of qubits were in a particular quantum state as a result of the performance of a quantum circuit or program by a quantum computer comprising the qubit or set of qubits.

For example, conventional discriminators (e.g., linear discriminators) consider each qubit measurement independently. Thus, each shot or instance of performing the quantum circuit or program is considered independently. For example, a conventional discriminator may use a machine learning-trained classifier to classify an individual qubit measurement (e.g., a single measurement of a single qubit) as either being in the first qubit state or the second qubit state (e.g., |0 [symbol] or |1 [symbol] ). However, due to the noise present in the qubit measurements, conventional discriminators are not able to map the individual qubit measurements to respective qubit states with high confidence.

As various embodiments consider the distribution function of a set of qubit measurements that includes a plurality of qubit measurements, the distribution/statistical information encoded in the distribution function enables the distribution function discriminator to provide high confidence mapping of a set of qubit measurements to measurement results (e.g., a probability that a qubit was in particular qubit state and/or the like probability that a set of qubits was in a particular (combined) quantum state as a result of the performance of the quantum circuit and/or program by the quantum computer). Thus, various embodiments provide improvements to the fields of quantum computing and quantum measurement result determination and interpretation.

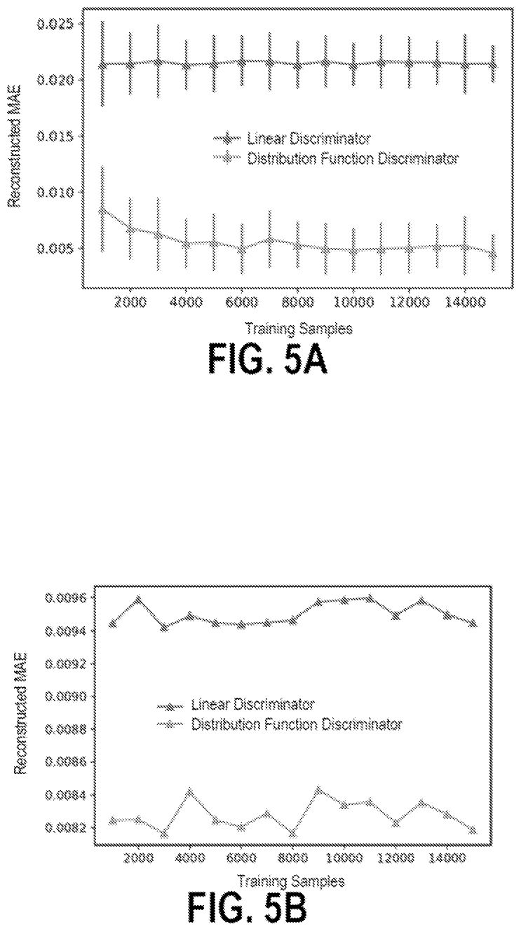

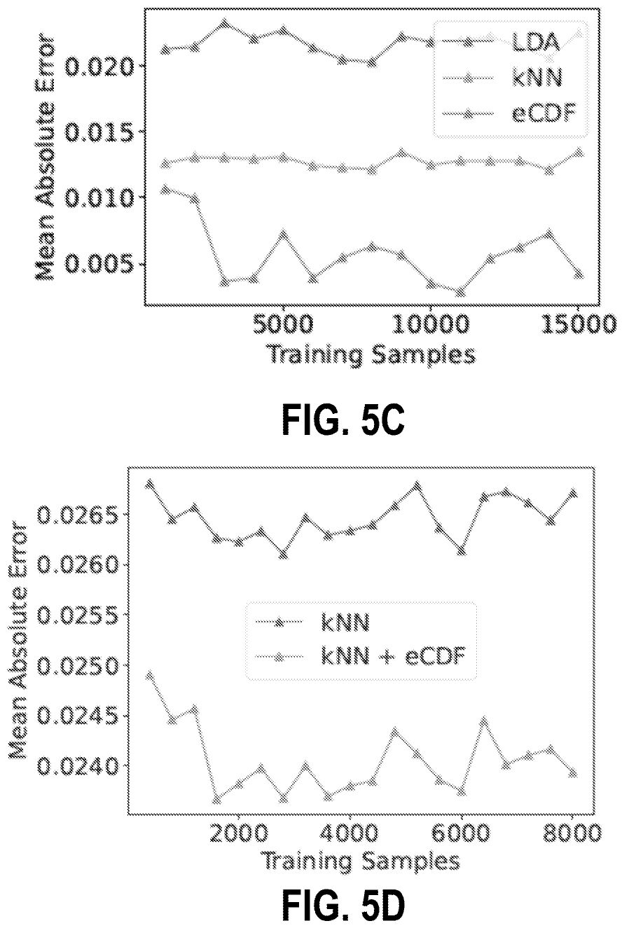

FIG. 5A provides a plot that illustrates the mean absolute error (MAE) for a conventional linear discriminator and an example embodiment of a distribution function discriminator for single qubit measurements (e.g., in accordance with the method illustrated by the flowchart of FIG. 3). The error bars depict one standard deviation in the sample mean MAE performance of each discriminator. FIG. 5B provides another plot that illustrates the MAE for reconstruction using a conventional linear discriminator and example embodiment of a distribution function discriminator for multi-qubit measurements (e.g., in accordance with the method illustrated by the flowchart of FIG. 4). FIG. 5C illustrates the MAE for various numbers of training samples for a conventional LDA discriminator, a conventional kNN discriminator, and an example distribution function discriminator (labeled eCDF on the plot) of an example embodiment. As can be seen from FIGS. 5A, 5B, and 5C, the distribution function discriminator provides lower MAE in both single qubit and multiple qubit scenarios than conventional discriminators.

Moreover, while various embodiments are described herein as determining a measurement result of one or more qubits, various embodiments may be used to determine a measurement result of one or more qudits defined by d quantum/qudit states (where d is a natural number of at least two).

FIG. 5D provides a plot showing the MAE for a multi-qutrit (e.g., a qudit with d=3) bit string reconstruction using a conventional kNN discriminator and the improvements provided thereto through the use of a modified bit string probability array according to an example embodiment (labeled kNN+eCDF on the plot). As can be seen form FIG. 5D, the distribution function discriminator provides more accurate results compared to conventional discriminators even in the case of qudits with d>2.

Thus, various embodiments provide improvements to the technical field of quantum measurement result determination and interpretation.

### Exemplary Classical Computing Entity

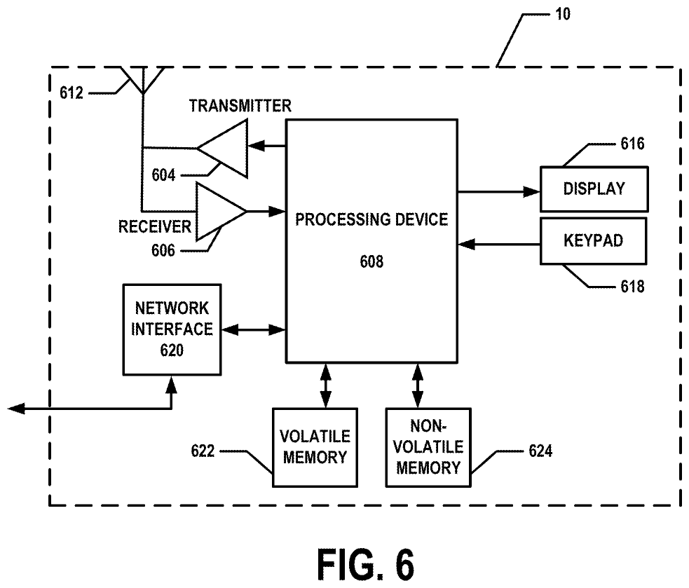

FIG. 6 provides an illustrative schematic representative of an example classical computing entity 10 that can be used in conjunction with embodiments of the present disclosure. As used herein, the term “classical” refers to semiconductor-based computing (e.g., semiconductor-based processing elements, semiconductor-based memory, and/or the like). In various embodiments, a classical computing entity 10 is configured to interface with a quantum computer 30. For example, the classical computing entity 10 is configured to interface with a quantum computer 30 so as to enable the classical computing entity 10 to receive pluralities of qubit measurements (e.g., one or more first pluralities of qubit measurements corresponding to a qubit being in a first qubit state, second pluralities of qubit measurements corresponding to a qubit being in a second state, sets of (single) qubit measurements, and/or sets of multi-qubit measurements). For example, the classical computing entity 10 may be configured to communicate with the quantum computer 30 to allow a user (e.g., a human user or a program operating on the classical computing entity 10) to receive, display, analyze, and/or the like output from the quantum computer 30.

As shown in FIG. 6, a classical computing entity 10 can include an antenna 612, a transmitter 604 (e.g., radio), a receiver 606 (e.g., radio), and a processing element 608 that provides signals to and receives signals from the transmitter 604 and receiver 606, respectively. The signals provided to and received from the transmitter 604 and the receiver 606, respectively, may include signaling information/data in accordance with an air interface standard of applicable wireless systems to communicate with various entities, such as a quantum computer 30, other classical computing devices, and/or the like. In this regard, the classical computing entity 10 may be capable of operating with one or more air interface standards, communication protocols, modulation types, and access types.

For example, the classical computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the classical computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The classical computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the classical computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The classical computing entity 10 can also download changes, add-ons, and updates, for instance, to its firmware, software (e.g., including executable instructions, applications, program modules), and operating system.

In various embodiments, the classical computing entity 10 may comprise a network interface 620 for interfacing and/or communicating with the quantum computer 30 and/or other classical computing devices, for example. In various embodiments, the classical computing entity 10 and the quantum computer 30 may communicate via a direct wired and/or wireless connection and/or via one or more wired and/or wireless networks 20.

In various embodiments, the processing element 608 may comprise one or more processing devices such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, graphics processing units (GPUs), central processing units (CPUs), other processing devices and/or circuitry, and/or the like. The term circuitry may refer to an entirely hardware embodiment or a combination of hardware and computer program products.

The classical computing entity 10 may also comprise a user interface device comprising one or more user input/output interfaces (e.g., a display 616 and/or speaker/speaker driver coupled to a processing element 608 and a touch screen, keyboard, mouse, and/or microphone coupled to a processing element 608). For instance, the user output interface may be configured to provide an application, browser, user interface, interface, dashboard, screen, webpage, page, and/or similar words used herein interchangeably executing on and/or accessible via the classical computing entity 10 to cause display or audible presentation of information/data and for interaction therewith via one or more user input interfaces. The user input interface can comprise any of a number of devices allowing the classical computing entity 10 to receive data, such as a keypad 618 (hard or soft), a touch display, mouse, voice/speech or motion interfaces, scanners, readers, or other input device. In embodiments including a keypad 618, the keypad 618 can include (or cause display of) the conventional numeric (0-9) and related keys (#, *), and other keys used for operating the classical computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the classical computing entity 10 can collect information/data, user interaction/input, and/or the like.

The classical computing entity 10 can also include (classical) volatile storage or memory 622 and/or non-volatile storage or memory 624, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the classical computing entity 10 (e.g., such as the distribution function discriminator).

### CONCLUSION

Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for providing an indication of a measurement result of a set of quantum measurements, the method performed by a distribution function discriminator operating on a classical computing entity, the method comprising:
obtaining a set of qudit measurements, the set of qudit measurements comprising a plurality of qudit measurements that each correspond to a respective quantum state of one or more qudits as a result of performance of a quantum circuit by a quantum computer comprising the one or more qudits;
determining a respective distribution function for each qudit of the one or more qudits based at least in part on the set of qudit measurements;
obtaining respective distribution functions for each qudit state of the one or more qudits of the quantum computer;
for each qudit of the one or more qudits, determining a respective bit probability for a first qudit state of the qudit based on the respective distribution function for the qudit and the respective distribution functions for each qudit state of the one or more qudits;
determining a measurement result based on the respective bit probability for each of the one or more qudits; and
providing an indication of the measurement result.

2. The method of claim 1, wherein each qudit measurement of the plurality of qudit measurements comprises a respective in-phase component and a respective quadrature component.

3. The method of claim 2, wherein each of the respective distribution functions is a product of a respective in-phase component distribution function and a respective quadrature component distribution function.

4. The method of claim 1, wherein the respective distribution functions for each qudit and the respective distribution functions for each qudit state are respective cumulative distribution functions.

5. The method of claim 4, wherein the respective cumulative distribution functions are empirically determined cumulative distribution functions.

6. The method of claim 1, wherein the respective bit probability for a respective qudit of the one or more qudits is determined by minimizing a probability constraint statement.

7. The method of claim 6, wherein the probability constraint statement for an jth qubit of the one or more qubits is of the form ∥(\hat{α}ⱼF(x)+(1−\hat{α}ⱼ)G(x))−Hⱼ(x)∥, where \hat{α}ⱼ is the probability that the jth qudit measurement result is the first qudit state, F(x) is the respective distribution function for the first qudit state, G(x) is the respective distribution function for one or more qudit states other than the jth qudit state, and Hⱼ(x) is the respective distribution function for the jth qudit.

8. The method of claim 1, wherein the one or more qudits comprise a plurality of qudits, and the method further comprises:
determining a plurality of bit strings, each bit string corresponding to a respective qudit measurement of the plurality of qudit measurements; and
defining an initial bit string probability array that indicates a respective frequency with which each unique bit string is present in the plurality of bit strings;
wherein determining the measurement result based on the respective bit probability for each of the one or more qubits comprises:
defining bit string constraints based on the respective bit probability for each of the one or more qudits;
determining a modified bit string probability array based at least in part on the bit string constraints and the initial bit string probability array; and
determining the measurement result based at least in part on the modified bit string probability array.

9. The method of claim 7, wherein the plurality of bit strings is determined by individually analyzing the plurality of qudit measurements using one or more linear discriminators.

10. The method of claim 7, wherein determining the modified bit string probability array comprises identifying a candidate bit string probability array that (a) satisfies each of the bit string constraints and (b) minimizes a difference between the candidate bit string probability array and the initial bit string probability array.

11. A classical computing entity comprising at least one processing element and at least one non-transitory memory storing executable instructions configured for providing a distribution function discriminator, the executable instructions, when executed by the at least one processing element, is configured to cause the classical computing entity to perform:
obtaining a set of qudit measurements, the set of qudit measurements comprising a plurality of qudit measurements that each correspond to a respective quantum state of one or more qudits as a result of performance of a quantum circuit by a quantum computer comprising the one or more qudits;
determining a respective distribution function for each qudit of the one or more qudits based at least in part on the set of qudit measurements;
obtaining respective distribution functions for each qudit state of the one or more qudits of the quantum computer;
for each qudit of the one or more qudits, determining a respective bit probability for a first qudit state based on the respective distribution function for the qudit and the respective distribution functions for each of the qudit states;
determining a measurement result based on the respective bit probability for each of the one or more qudits; and
providing an indication of the measurement result.

12. The classical computing entity of claim 11, wherein the at least one processing element comprises at least one of a central processing unit (CPU), a field-programmable gate array (FPGA), or a graphical processing unit (GPU).

13. The classical computing entity of claim 11, wherein each qudit measurement of the plurality of qudit measurements comprises a respective in-phase component and a respective quadrature component.

14. The classical computing entity of claim 13, wherein each of the respective distribution functions is a product of a respective in-phase component distribution function and a respective quadrature component distribution function.

15. The classical computing entity of claim 11, wherein the respective distribution functions for the each qudit and each of the qudit states are respective cumulative distribution functions.

16. The classical computing entity of claim 11, wherein the respective bit probability for a respective qudit of the one or more qudits is determined by minimizing a probability constraint statement.

17. The classical computing entity of claim 11, wherein the one or more qudits comprise a plurality of qudits, and the method further comprises:
determining a plurality of bit strings, each bit string corresponding to a respective qubit measurement of the plurality of qudit measurements; and
defining an initial bit string probability array that indicates a respective frequency with which each unique bit string is present in the plurality of bit strings;
wherein determining the measurement result based on the respective bit probability for each of the one or more qudits comprises:
defining bit string constraints based on the respective bit probability for each of the one or more qudits;
determining a modified bit string probability array based at least in part on the bit string constraints and the initial bit string probability array; and
determining the measurement result based at least in part on the modified bit string probability array.

18. The classical computing entity of claim 17, wherein the plurality of bit strings is determined by individually analyzing the plurality of qudit measurements using one or more linear discriminators.

19. The classical computing entity of claim 17, wherein determining the modified bit string probability array comprises identifying a candidate bit string probability array that (a) satisfies each of the bit string constraints and (b) minimizes a difference between the candidate bit string probability array and the initial bit string probability array.

20. A computer program product comprising at least one non-transitory storage medium, the at least one storage medium storing computer executable instructions configured for providing a distribution function discriminator, the executable instructions configured to, when executed by a processing element of a classical computing entity, cause the classical computing entity to perform:
obtaining a set of qudit measurements, the set of qudit measurements comprising a plurality of qudit measurements that each correspond to a respective quantum state of one or more qudits as a result of performance of a quantum circuit by a quantum computer comprising the one or more qudits;
determining a respective distribution function for each qudit of the one or more qudits based at least in part on the set of qudit measurements;
obtaining respective distribution functions for each qudit of the one or more qudits of the quantum computer;
for each qudit of the one or more qudits, determining a respective bit probability for a first qudit state based on the respective distribution function for the qudit and the respective distribution functions for each of the qudit states;
determining a measurement result based on the respective bit probability for each of the one or more qudits; and
providing an indication of the measurement result.
